(19) United States
(12) Patent Application Publication
(10) Pub. No.: US 2008/0225437 A1
(43) Pub. Date: Sep. 18, 2008

(54) Head gimbal assembly with low head disk interaction response

(76) Inventors: Yen Fu, San Jose, CA (US); Qinghua Zeng, Fremont, CA (US); Ellis T. Cha, San Ramon, CA (US); Hong Tian, Hong Lok Yuen (HK)

Correspondence Address: KENYON & KENYON LLP, RIVERPARK TOWERS, SUITE 600, 333 W. SAN CARLOS ST., SAN JOSE, CA, 95110, US

(21) Appl. No.: 11/725,004

(22) Filed: Mar. 16, 2007

(51) Int. Cl. G11B 17/32; G11B 5/60

(52) U.S. Cl. 360/224; 360/234.3

(57) ABSTRACT

Methods and an apparatus for producing a head gimbal assembly with minimum dynamic response and air bearing resonance during flight (e.g., head-disk contact), thereby minimizing disruptions in the desired uniformity of flying height, are described. Embodiment head gimbal assemblies may comprise at least one air bearing surface of a slider and at least one suspension assembly wherein the at least one air bearing surface of the slider and the at least one suspension assembly are individually modeled. In addition, one of the at least one air bearing surface of the slider and one of the at least one suspension assembly may be matched to minimize air bearing resonance and system dynamic response.

### BACKGROUND OF THE INVENTION

A. Field of the Invention

The present invention is directed to head gimbal assemblies utilized in hard disk drive assemblies. More specifically, the present invention pertains to an optimized head gimbal assembly design for better dynamic performance.

B. Description of the Related Art

Presently, the hard disk drive industry is observing great success in the consumer electronics environment. One of the main reasons for this success is the ability to achieve ever increasing storage capacity reflecting consumer demand in ever decreasing form factors (e.g., greater than 1 Gb in 1″ disks and below for portable music players). So far, these advancements are being achieved with minimal cost compared to competitors (e.g., flash memory).

However, continuing these advances require overcoming arising design and manufacturing difficulties. These difficulties can be found both in the drive level and the component level.

Hard disk drives (HDD) are normally utilized as the major storage units in a computer. Generally, HDDs operate by retrieving and storing digitized information stored on a rotating disk. This retrieving and storing (i.e., “reading” and “writing”) is done by a magnetic “head” embedded on a ceramic “slider” which is mounted on a “suspension”. The assembled structure of slider and suspension is usually called the head gimbal assembly (HGA).

A typical slider body is shown in FIG. 1. As shown in FIG. 1, an air bearing surface (ABS) design 102 known for a common slider 104 may be formed with a pair of parallel rails 106 and 108 that extend along the outer edges of the slider surface facing the disk. The two rails 106 and 108 typically run along at least a portion of the slider body length from the leading edge 110 to the trailing edge 112. The leading edge 110 is defined as the edge of the slider that the rotating disk passes before running the length of the slider 104 towards a trailing edge 112. The transducer or magnetic element 114 is typically mounted at some location along the trailing edge 112 of the slider as shown in FIG. 1.

The operation of a typical slider is shown in FIG. 2. A suspension 204 supports the head gimbal assembly (HGA) 202 over the moving disk 206 (having edge 208) and moving in the direction indicated by arrow 210. Suspension assembly 204 typically consists of multiple components, including a loadbeam, gimbal, electrical traces, a hinge and a baseplate. In operation of the disk drive, as shown in FIG. 2, an actuator 212, including an actuator arm moves the HGA (with the help of an actuator driving mechanism) over various diameters of the disk 206 (e.g., inner diameter (ID), middle diameter (MD) and outer diameter (OD)) over arc 214. A spindle motor coupled to a base may rotate, with the help of a pivot assembly, the disk relative to the base.

In order to achieve maximum hard disk drive performance, the head must fly as close to the surface of the disk as possible while still maintaining a consistent, required spacing. This spacing is also known as the “flying height” or “magnetic spacing” of the disk. When a disk is rotated, it carries with it a small amount of flowing air (substantially parallel to the tangential velocity of the disk) on its surface that acts to support a magnetic head flying above, thereby creating the “flying height” of the head above the disk. Typically, the slider supporting the head is aerodynamically shaped to use the flow of this small amount of air to maintain a uniform distance from the surface of the rotating disk (e.g., 10 nm), thereby preventing the head from contacting the disk. The surface of the magnetic head closest to the disk (and being supported by the flowing air) is referred to as the “air bearing surface”. In order to make the slider fly stably and reliably in such a small gap, various design and geometric criteria including vertical stiffness (K_{z}), gimbal pitch and roll stiffness (Kₚ, Kᵣ), gimbal static attitude—including pitch and roll attitude (PSA/RSA), and operational shock performance (G/gram) must be optimally designed and maintained to ensure performance.

In order to continue the current advances in disk drive technology, two main design criteria must be continuously addressed and improved upon: a) the flying height and b) the surface roughness of the various disk drive components, while maintaining optimum flying characteristics of the head (e.g., crown, camber, twist, overcoat and pole tip recession).

Fluctuations in flying height are known to adversely affect the resolution and the data transfer capabilities of the accompanying transducer or read/write element. The amplitude of the signal being recorded or read does not vary as much when the flying height is relatively constant. Additionally, changes in flying height may result in unintended contact between the slider assembly and the magnetic rotating disk.

A constant flying height may be more readily achieved through particular ABS designs. Sliders are generally considered to be either direct contacting, pseudo-contacting or flying sliders which is descriptive of their intended contact with a rotating disk. However, regardless of the type of slider, it is often desirable to avoid unnecessary contact with the surface of the spinning magnetic disk so as to reduce the wear on both the slider body and the disk. The deterioration or wear of the recording media may lead to the loss of recorded data, while slider wear may also result in the ultimate failure of the transducer or magnetic element.

What often causes changes to the flying height is the continual high speed movement of the slider across the rotating disk, while performing read or write operations. For example, depending on the radial position of the slider, the respective linear velocity of the disk varies. Higher velocities are observed at the outer edge of the rotating disk, while lower velocities are found at the inner edge. As a result, the air bearing slider flies at different relative speeds at different radial positions relative to the disk. Because sliders typically fly higher at higher velocities, there is a tendency for flying heights to increase when positioned above the outer regions of the disk. At the same time, lower velocities at the inner regions of the disk cause the slider to fly lower. Accordingly, slider designs must account for the noticeable effect that variations in radial position, and relative velocity, have on the flying height.

In FIG. 1, the rails 106 and 108 form the air bearing surface on which the slider flies, and provide the necessary lift upon contact with the air flow created by the spinning disk. As the disk rotates, the generated wind or air flow runs along underneath, and in between, the slider rails 106 and 108. As the air flow passes beneath the rails 106 and 108, the air pressure between the rails and the disk increases thereby providing positive pressurization and lift. In general, as the air bearing surface area increases, the amount of lift created is also increased. Therefore, as a design criteria, there is a need for a method that allows for design of a flying height constituting the minimal amount of spacing between the head and the disk required for successful operation of the hard disk drive.

Second, any surface roughness issues must be addressed to overcome any associated friction issues that might impede the head's ability to fly as close to the surface of the disk as possible. Along with general frictional resistance due to the moving parts of the disk drive (e.g., the disk, the loading/unloading zones or the magnetic head), excessive surface roughness of either the disk or the magnetic head significantly increases the chances of HDI (head disk interaction), often resulting in intermittent contact and/or crashes. However, while it is possible to smoothen these surfaces, continuously increasing the smoothness comes with problems as well. Smoother surfaces lead to increased inter-molecular (Van der Waal's) forces acting at the interface and higher sensitivity to altitude and pressure changes during operational mode. Both of these factors may cause increased undesired variations in the flying height. Therefore, there is a need for a cost-effective process that can easily attain the desired smoothness of the disk designed for optimum performance.

In addition, the flying height and the surface roughness of the disk drive components must be designed to preserve the mechanical operating parameters of the head, such as crown, camber and twist. The “crown” represents a deformation in shape along forward and aft directions of the slider (as shown by the Y-Y plane), and the “camber” represents a deformation in shape along lateral directions of the magnetic head slider (as shown by X-X plane). Crown and camber are shown in FIG. 3.

Another requirement is the suspension assembly have little or no “dynamic effect” on the performance of the slider air bearings. A dynamic effect is the result of head-disk contact. This may result from contact, or operation in higher altitudes where the air is thinner (thereby lowering the flying height). As a result, the suspension and the slider are both set into motion, causing the dynamic effect.

An example of the response of the slider maintaining a minimized dynamic effect upon hitting a bump on the disk is exhibited in FIG. 4. As shown, in a very wide frequency range, there are only two peaks on the curve representing a major variation in the slider displacement, both of which (due to superior damping properties exhibited upon minimizing the dynamic effect) are steadily and quickly normalized. Specifically, the displacement of the slider is more than two (2) nanometers only at two frequencies (˜100 kHz, ˜320 kHz), and the slider recovers to its normal displacement relatively quickly.

FIG. 5 shows the response of a slider embodiment after the slider hits a bump where the “dynamic effect” is not minimized. As illustrated, the displacement curve can have many sharp peaks, even at the low frequency ranges. Also, the damping characteristics are hindered due to the greater dynamic effects between the suspension and the slider air bearings, thereby making it very difficult for the slider's displacement to normalize to a proper range. Specifically, the illustration shows at least twelve instances where the displacement is greater than two (2) nanometers, and the slider takes a relatively much longer period to recover, and certainly does not do so gradually. This sustained variance (the continuous peaks in displacement) in the slider's flight may lead to instability during read/write operations, and eventually performance failure.

In addition, along with the dynamic effect, the loadbeam of the suspension assembly can play an important role in slider performance as well. Thin, lightweight suspensions are often utilized to achieve high operational shock performance. These suspension perform optimally under shock conditions because generally the lighter the suspension, the less of an effect it will have on the flying height and performance of the air bearing surface of the slider.

Therefore, it is clear that both the dynamic performance design of the slider and the loadbeam design of the suspension have a significant effect on the displacement characteristics of an HGA embodiment. This is especially true in the resonance range of 10 kHz to 250 kHz, the typical range of resonance a slider head experiences after contact with the disk due to shock, loading/unloading, and contact with debris. If this dynamic effect of the suspension on the slider air bearings is not minimized, the slider has the potential to hit a bump during flight, upon which the head gimbal assembly's inability to recover may lead to operational failure.

In achieving aforementioned ever-decreasing form factors, reducing suspension's dynamic effects on these slider air bearing becomes more and more critical. However, the current HGA design methods fail to take into account two essential critical design considerations. First, in the current head gimbal design process, air bearing design (e.g., the dynamic effect) and suspension design (e.g., the loadbeam characteristics) are designed without consideration to the other. Second, current head gimbal assembly designs do not consider that the operational characteristics (e.g., dynamic effects) of the integrated structure are predicated upon the individualized characteristics of the air bearing surfaces and suspension assemblies. Therefore, there is a need for a developing a new design method for HGAs capable of overcoming the aforementioned deficiencies and producing optimum flying characteristics in a in a cost-efficient manner.

### BRIEF DESCRIPTION OF THE DRAWINGS

FIG. 1 provides an illustration of a typical slider.

FIG. 2 provides an illustration of the typical operation of a typical slider.

FIG. 3 provides an illustration of crown and camber on a slider body.

FIG. 4 provides an illustration of an exemplary slider's (with suspension effects are minimized) response after it hits a bump on a disk.

FIG. 5 provides an illustration of an exemplary slider's (with suspension effects are not minimized) response after it hits a bump on a disk.

FIG. 6a provides an illustration of an exemplary slider with a thin, lightweight loadbeam suspension design.

FIG. 6b provides an illustration of an exemplary slider with a thin, lightweight loadbeam suspension design responds after it hits a bump on a disk.

FIG. 7a provides an illustration of an exemplary slider with a locally stiffened loadbeam suspension design.

FIG. 7b provides an illustration of an exemplary slider with a locally stiffened loadbeam suspension design responds after it hits a bump on a disk.

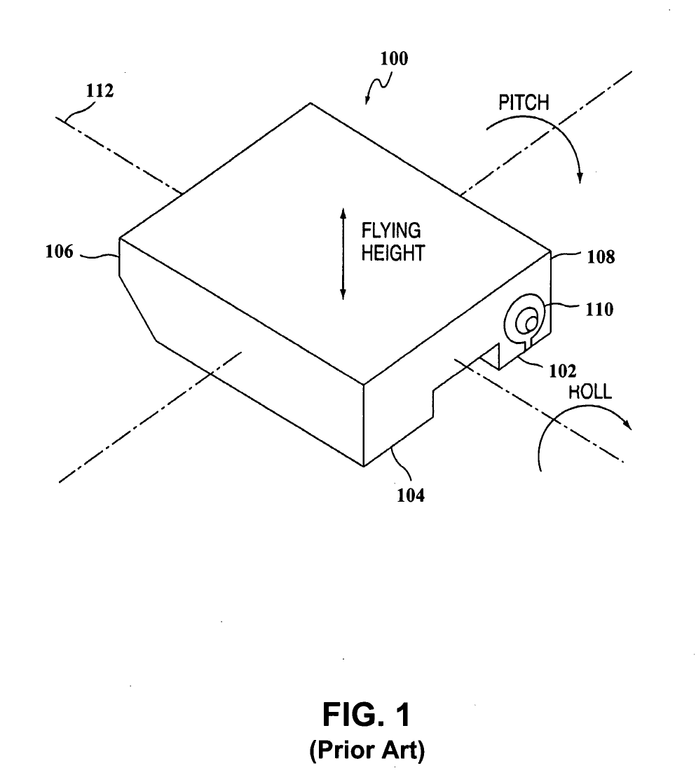

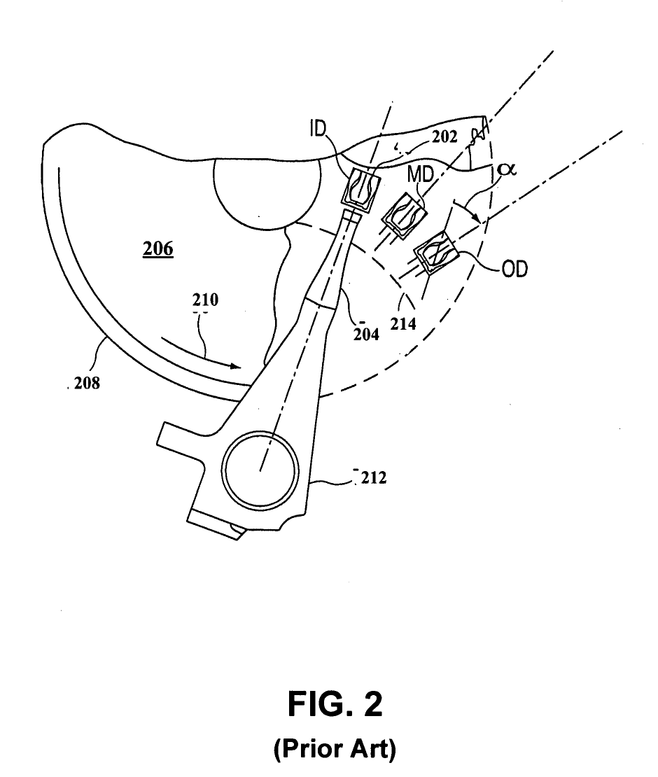

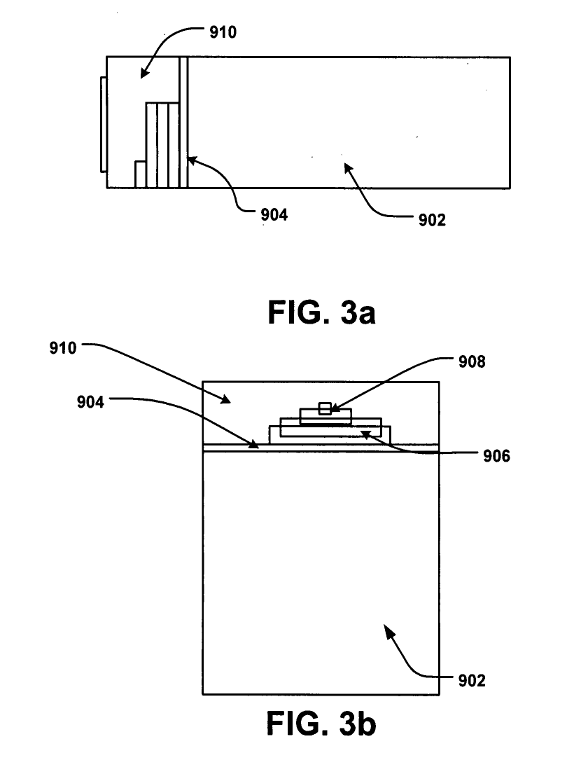

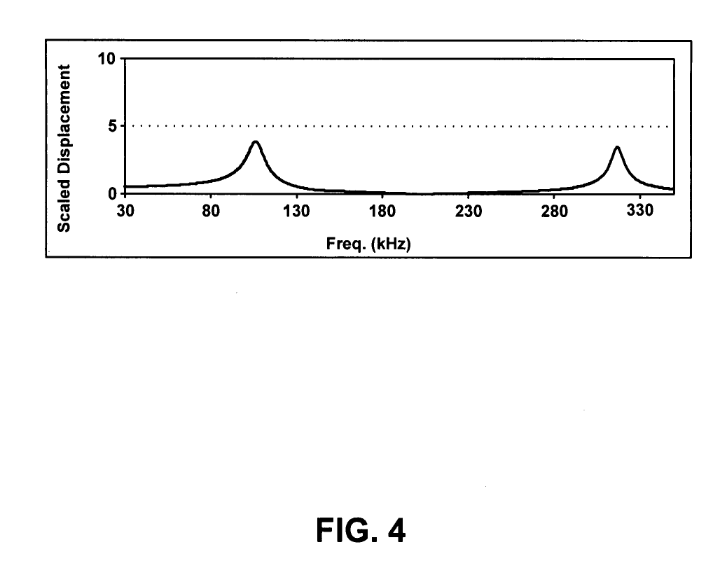

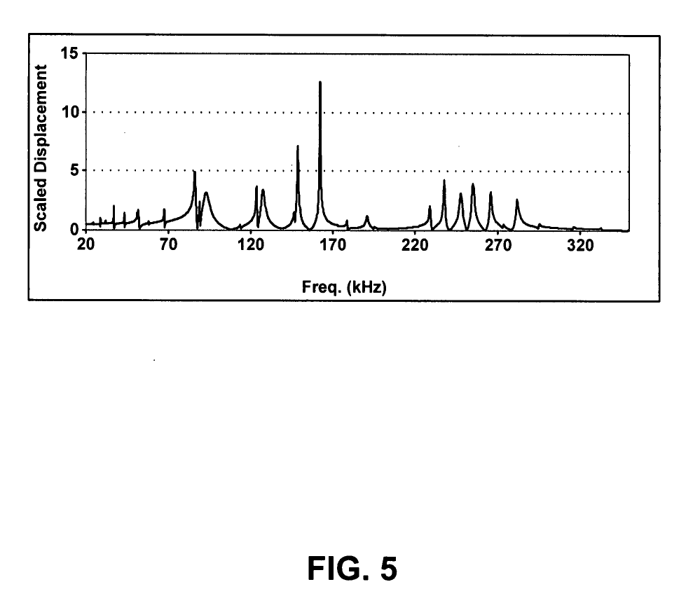

### DETAILED DESCRIPTION OF THE DRAWINGS

A method and apparatus for producing a head gimbal assembly with minimum dynamic response and air bearing resonance during flight is provided, thereby minimizing disruptions in the desired uniformity of flying height. In embodiments of the present application, the suspension design is uniquely optimized based on the dynamic effects and resonance characteristics of the air bearing surfaces of the slider and the suspension design.

One method to achieve a desired head gimbal assembly design according to an embodiment of the present invention is to conduct modeling with suspension assemblies with particularized air bearing features. In doing so, however, it is important to understand the roles of and the relationship between the suspension and the slider in dissipating energy during and after a contact event. These two are interrelated, and the optimal synchronicity of these two design elements leads to a more efficient and effective head gimbal assembly design.

During a contact event, part of the total energy is directed toward the suspension and part is directed toward the slider. However, the total energy directed toward the suspension may not be absorbed by the suspension, and the total energy directed toward the slider may not be absorbed by the slider. In this case, part of the excess energy from the suspension is redirected toward the slider, and part of the excess energy from the slider is redirected toward the suspension. Therefore, for any head gimbal assembly design, it is very important to first ascertain the resonance interplay between the suspension and slider. Embodiments of the present invention may achieve this by modeling the resonance response of the structure as a whole by examining the individual contributions of the suspension and the slider designs. The results of the modeling of the combined structure are used to determine which suspension assembly/air bearing design combinations generate the least dynamic effect response under disk-contact or high-resonance conditions.

Another method to achieve an optimized design according to the present invention is to conduct the modeling and testing on the suspension assembly and the air bearing features of the slider separately. In this method, the frequencies of the resonance modes of each of the two components (the air bearing surfaces and the suspension assembly) are compared, and subsequently matched to achieve an optimum combination.

Optimally matching a particular suspension design with a particular air bearing design can lead to a more stable combined structure. For example, if the air bearing design experiences a peak resonance at 100 kHz, and the suspension assembly experiences a peak resonance at 101 kHz, there is a high risk the combination apparatus will be easily excitable and more likely to fail at ˜100 kHz. However, if on the other hand, the two components are chosen such that one component tends to normalize the complete apparatus when the other component experiences a peak resonances and vice versa, the overall stability of the apparatus throughout the whole resonance spectrum is increased, and a uniform flying height is more quickly restored upon a contact event. Therefore, in embodiments of the present invention, the suspension assembly and the slider air bearing surfaces are individually modeled and paired together to avoid overlap of individual resonance peaks.

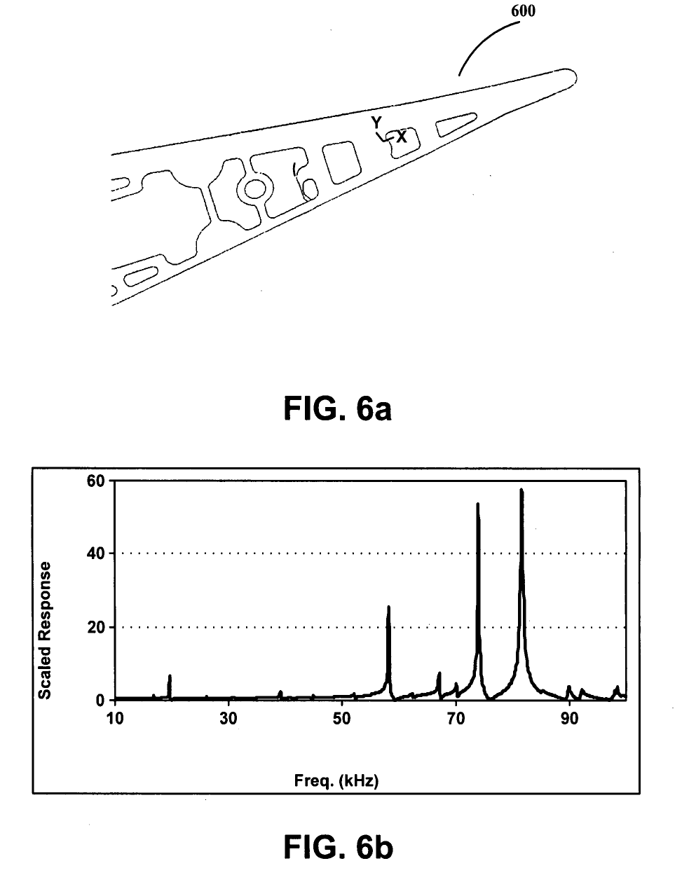

FIG. 6a illustrates a suspension design with a thin, lightweight load beam 600 modeled according to an embodiment of the present invention. The head-disk interaction (HDI) resulting after the slider hits a bump on the disk is illustrated in FIG. 6b. FIG. 6b shows two large resonance modes with head disk contact response over 50 units (see between 70 kHz and 90 kHz). Based on this model, it was observed that the load beam design is relatively weak in this range.

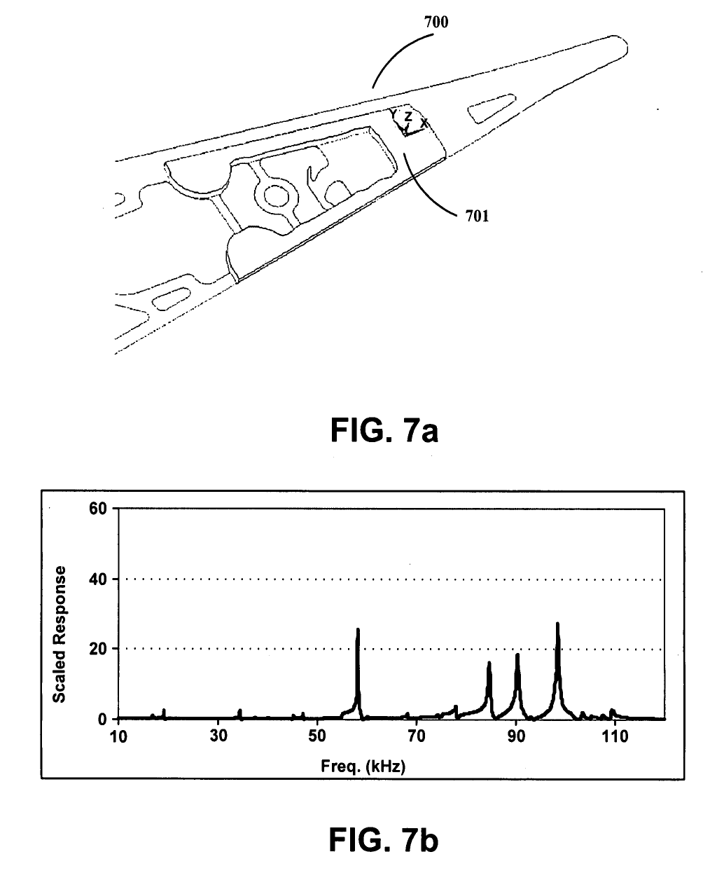

FIG. 7a illustrates an improved suspension design 700 with stiffened load beam 701 designed according to an embodiment of the present invention to overcome the weaknesses discovered in the example modeled above (FIG. 6b). The HDI results of the HGA apparatus including the improved suspension design are shown in FIG. 7b. As evident, by substituting the previous suspension design with a new suspension design designed to overcome its weaknesses, the peak resonance was reduced in half, and the response of the HGA was generally more normalized and uniform.

Similarly, by comparing multiple slider air bearing designs with respect one or more suspension designs, and utilizing the modeling results to predict the resonance and dynamic response of a HGA utilizing both components, a more optimal HGA design may be achieved as well.

The two methods described hereinabove may used separately or in conjunction to design a optimal head gimbal assembly apparatus.

While the present invention has been described with reference to the aforementioned applications, this description of the preferred embodiments is not meant to be construed in a limiting sense. It shall be understood that all aspects of the present invention are not limited to the specific depictions, configurations or dimensions set forth herein which depend upon a variety of principles and variables. Various modifications in form and detail of the disclosed apparatus, as well as other variations of the present invention, will be apparent to a person skilled in the art upon reference to the present disclosure. It is therefore contemplated that the appended claims shall cover any such modifications or variations of the described embodiments as falling within the true spirit and scope of the present invention.

What is claimed is:

1. A method comprising:
modeling at least one air bearing surface of a slider;
independently modeling at least one suspension assembly separate from the modeling of the at least one air bearing surface of the slider; and
minimizing air bearing resonance and system dynamic response of a head gimbal assembly responsive to said modeling operations.

2. The method of claim 1, wherein said minimizing further comprises comparing the results of the models to determine overlap of resonance peaks of the at least one air bearing surface of the slider and the at least one suspension assembly.

3. The method of claim 1, wherein said minimizing further comprises matching one of the at least one air bearing surface of the slider and one of the at least one suspension assembly.

4. The method of claim 3, wherein the matching is done to minimize air bearing resonance from 10 kHz to 250 kHz.

5. The method of claim 3, wherein the matching of the one of the at least one air bearing surface of the slider and the one of the at least one suspension assembly is done to avoid overlap of resonance modes of the one of the at least one air bearing surface of the slider and the one of the at least one suspension assembly.

6. The method of claim 1, wherein the head gimbal assembly further comprises damping materials to improve the air bearing resonance and system dynamic response.

7. The method of claim 1, further comprising predicting the air bearing resonance and system dynamic response of a head gimbal assembly.

8. A apparatus comprising:
at least one air bearing surface of a slider; and
at least one suspension assembly;
wherein the at least one air bearing surface of the slider and the at least one suspension assembly are modeled to minimize air bearing resonance and system dynamic response of a head gimbal assembly.

9. The apparatus of claim 8, further comprising comparing the results of the models to determine overlap of resonance peaks between the at least one air bearing surface of the slider and the at least one suspension assembly.

10. The apparatus of claim 8, further comprising matching the one of the at least one air bearing surface of the slider and one of the at least one suspension assembly.

11. The apparatus of claim 10, wherein the matching is done to minimize air bearing resonance from 10 kHz to 250 kHz.

12. The apparatus of claim 10, wherein the matching is done to avoid overlap of resonance modes of the one of the at least one air bearing surface of the slider and the one of the at least one suspension assembly.

13. The apparatus of claim 8, further comprising damping materials to improve the air bearing resonance and system dynamic response.

14. The apparatus of claim 8, further comprising predicting the air bearing resonance and system dynamic response of a head gimbal assembly.

15. A system comprising:
a disk containing data;
a spindle motor coupled to the base to rotate the disk relative to the base;
a pivot assembly to facilitate rotation around an axis;
a slider;
a head gimbal assembly further comprising:
an actuator arm to position the slider above a storage disk;
an actuator driving mechanism to rotate the actuator arm;
at least one air bearing surface of a slider; and
at least one suspension assembly to couple the slider to the actuator arm;
wherein the at least one air bearing surface of the slider and the at least one suspension assembly are modeled to minimize air bearing resonance and system dynamic response of a head gimbal assembly.

16. The system of claim 15, further comprising comparing the results of the models to determine overlap of resonance peaks between the at least one air bearing surface of the slider and the at least one suspension assembly.

17. The system of claim 15, further comprising matching the one of the at least one air bearing surface of the slider and one of the at least one suspension assembly.

18. The system of claim 17, wherein the matching is done to minimize air bearing resonance from 10 kHz to 250 kHz.

19. The system of claim 17, wherein the matching is done to avoid overlap of resonance modes of the one of the at least one air bearing surface of the slider and the one of the at least one suspension assembly.

20. The system of claim 15, further comprising damping materials to improve the air bearing resonance and system dynamic response.

21. The system of claim 15, further comprising predicting the air bearing resonance and system dynamic response of a head gimbal assembly.

22. A method comprising:
identifying a first effect on a suspension of a head gimbal assembly from a slider of a head gimbal assembly responsive to a contact event;
identifying a second effect on the slider from the suspension.

23. The method of claim 22, further comprising modeling the head gimbal assembly based on the first and second effects.

24. The method of claim 23, further comprising minimizing air bearing resonance and system dynamic response of a head gimbal assembly responsive to first and second effects.

25. The method of claim 22, further comprising iterating the identifying of the first effect and the identifying of the second effect.

26. The method of claim 25, wherein the iterating is to minimize air bearing resonance and system dynamic response of the head gimbal assembly.

27. The method of claim 22, where in the first effect and second effect are resonance effects.

28. The method of claim 22, further comprising
modeling at least one air bearing surface of the slider;
independently modeling the suspension assembly separate from the modeling of the at least one air bearing surface of the slider; and
minimizing air bearing resonance and system dynamic response of a head gimbal assembly responsive to said modeling.

29. The method of claim 28, wherein said minimizing further comprises comparing the results of the models to determine overlap of resonance peaks between the at least one air bearing surface of the slider and the at least one suspension assembly.

30. The method of claim 28, wherein said minimizing further comprises matching one of the at least one air bearing surface of the slider and one of the at least one suspension assembly.

31. The method of claim 22, wherein the matching is done to minimize air bearing resonance from 10 kHz to 250 kHz.

32. The method of claim 22, wherein the matching is done to avoid overlap of resonance modes of the one of the at least one air bearing surface of the slider and the one of the at least one suspension assembly.

33. The method of claim 22, wherein the head gimbal assembly further comprises damping materials to improve the air bearing resonance and system dynamic response.

34. The method of claim 22, further comprising predicting the air bearing resonance and system dynamic response of a head gimbal assembly.

35. An apparatus comprising:
at least one air bearing surface of a slider; and
at least one suspension assembly;
wherein the at least one air bearing surface of the slider and the at least one suspension assembly are modeled by identifying a first effect on a suspension of a head gimbal assembly from a slider of a head gimbal assembly in response to a contact event and identifying a second effect on the slider from the suspension.

36. The apparatus of claim 35, further comprising modeling the head gimbal assembly based on the first and second effects.

37. The apparatus of claim 35, further comprising minimizing air bearing resonance and system dynamic response of a head gimbal assembly responsive to first and second effects.

38. The apparatus of claim 35, further comprising iterating the identifying of the first effect and the identifying of the second effect.

39. The apparatus of claim 35, wherein the iterating is to minimize air bearing resonance and system dynamic response of the head gimbal assembly.

40. The apparatus of claim 35, where in the first effect and second effect are resonance effects.

41. The apparatus of claim 35, further comprising
modeling at least one air bearing surface of the slider;
independently modeling the suspension assembly separate from the modeling of the at least one air bearing surface of the slider; and
minimizing air bearing resonance and system dynamic response of a head gimbal assembly responsive to said independently modeling.

42. The apparatus of claim 41, further comprising
wherein said minimizing further comprises comparing the results of the models to determine overlap of resonance peaks between the at least one air bearing surface of the slider and the at least one suspension assembly.

43. The apparatus of claim 41, wherein said minimizing further comprises matching one of the at least one air bearing surface of the slider and one of the at least one suspension assembly to minimize air bearing resonance and system dynamic response of a head gimbal assembly.

44. The apparatus of claim 41, wherein the matching is done to minimize air bearing resonance from 10 kHz to 250 kHz.

45. The apparatus of claim 35, wherein the matching is done to avoid overlap of resonance modes of the one of the at least one air bearing surface of the slider and the one of the at least one suspension assembly.

46. The apparatus of claim 35, wherein the head gimbal assembly further comprises damping materials to improve the air bearing resonance and system dynamic response.

47. The apparatus of claim 35, further comprising predicting the air bearing resonance and system dynamic response of a head gimbal assembly.

48. A system comprising:
a disk containing data;
a spindle motor coupled to the base to rotate the disk relative to the base;
a pivot assembly to facilitate rotation around an axis;
a slider;
a head gimbal assembly further comprising:
an actuator arm to position the slider above a storage disk;
an actuator driving mechanism to rotate the actuator arm;
at least one air bearing surface of a slider; and
at least one suspension assembly to couple the slider to the actuator arm;
wherein the at least one air bearing surface of the slider and the at least one suspension assembly are modeled by identifying a first effect on a suspension of a head gimbal assembly from a slider of a head gimbal assembly in response to a contact event and identifying a second effect on the slider from the suspension.

49. The system of claim 48, wherein said modeling includes comparing the results of the models to determine overlap of resonance peaks between the at least one air bearing surface of the slider and the at least one suspension assembly.

50. The system of claim 48, wherein the one of the at least one air bearing surface of the slider and one of the at least one suspension assembly are matched to minimize air bearing resonance and system dynamic response.

51. The system of claim 50, wherein the matching is done to minimize air bearing resonance from 10 kHz to 250 kHz.

52. The system of claim 50, wherein the matching is done to avoid overlap of resonance modes of the one of the at least one air bearing surface of the slider and the one of the at least one suspension assembly.

53. The system of claim 48, further comprising damping materials to improve the air bearing resonance and system dynamic response.

54. The system of claim 48, further comprising predicting the air bearing resonance and system dynamic response of a head gimbal assembly.
